(19) United States
(12) Patent Application Publication
(10) Pub. No.: US 2010/0193451 A1
(43) Pub. Date: Aug. 5, 2010

(54) Space-Saving, Themed Footwear Storage Rack

(76) Inventor: Paul Levine, Gloversville, NY (US)

Correspondence Address: LAW OFFICE OF JAY R. YABLON, 910 NORTHUMBERLAND DRIVE, SCHENECTADY, NY, 12309-2814, US

(21) Appl. No.: 12/756,163

(22) Filed: Apr. 7, 2010

Related U.S. Application Data
(60) Provisional application No. 61/252,409, filed on Oct. 16, 2009.

(51) Int. Cl. A47F 7/08; B23P 17/04

(52) U.S. Cl. 211/37; 29/428

(57) ABSTRACT

A themed footwear storage rack apparatus and related method, comprising: a base; a substantially vertically-oriented central support post attached to and maintained in said vertical orientation by said base; at least one tier of footwear support rods, each said footwear support rod comprising an attachment end thereof at which said support rod is attached to said central support post, and a distal end thereof; each said footwear support rod in each said tier connected at said attachment end thereof to said central support post, at: substantially the same vertical height, within four inches, as all other footwear support rods within said tier; a horizontal plane disposition angle theta which is substantially equal, within ten degrees, between each adjacent pair of support rods within said tier; and a vertical disposition angle phi of between 45 and 85 degrees from upward parallel alignment with said central support post; and a shoe rack theme embodied in a visual appearance of said central support post, well as on other components thereof.

### CROSS REFERENCE TO RELATED APPLICATIONS

This application claims priority of pending provisional application U.S. 61/252,409 filed Oct. 16, 2009, which is hereby incorporated by reference in its entirety.

### BACKGROUND OF THE INVENTION

While the prior art is crowded with various devices for storing human shoes and more generally footwear, the functional question of how to store footwear in a compact space in a visually-attractive way that motivates the regular usage of such devices presents an ongoing challenge to designers of various footwear storage devices.

Footwear is a mundane necessity of life. But to make virtue out of necessity, a worldwide industry has developed which manufactures and promotes shoes, sneakers, boots, etc. with a wide variety of decorative appearances, thus turning the footwear itself into a fashion statement. Market shares are obtained in relation to the brand names of various types of footwear, and those who follow these markets can tell at a glance whether someone is wearing the latest designer footwear or footwear from the “in” manufacturer.

For all the attention which is given to the appearance of footwear while it is being worn, and while the prior art reveals a fair number of footwear supports and racks as summarized in an information disclosure filed herewith, virtually no attention is given to the supports and racks which are used to store footwear while the footwear is not in use. It would be desirable to have not only footwear, but a footwear storage device which generates interest through a variety of culturally, economically, or educationally-popular “themes,” adding to the utility and attractiveness of these devices, and motivating the good use of these devices.

Of particular background interest are U.S. Pat. No. 1,074,888 for a shoe drier, U.S. Pat. No. 2,205,817 for a shoe rack, U.S. Pat. No. 3,421,762 for a dismantlable pegged target which serves as an amusement device, U.S. Pat. No. 3,798,788 for a boot and glove drying device, U.S. Pat. No. 5,065,871 for a multi-deck type of rotary shoe rack which deodorizes shoes, and U.S. Pat. No. 5,469,635 for baby bottle dryers. Although these references and some of the others cited in the information disclosure have superficial similarities in appearance to the shoe rack disclosed therein, none of these references disclose, suggest, or motivate configuring these devices to add utility and attractiveness by embodying a variety of “themes” to these devices, and/or adding “themes” in the manner taught herein.

While used herein as an example not a limitation, the development of various culturally-popular “sports” themed storage racks, e.g., for baseball, football, basketball, etc., not only makes these racks more attractive and interesting and distinctive, but increases the chance that they will actually be used for storing footwear, as opposed to being ignored while shoes are taken off and simply thrown down in a mess somewhere on a floor. For example, a small child will be induced to develop habits of neatness and organization with respect to his or her shoes and clothing, if the child can store his or her shoes on a rack which has elements which display his or her favorite sports teams, or which contains figurines associated with his or her favorite sport, or other interest, in contrast to a bare, unadorned show rack.

Thus, it is desirable to have a footwear storage rack which is configured not only for the efficient, space-saving storage of footwear, but which adds interest, in the form of various attractive themes, which will further induce users to make good use of this rack for the organized storage of their footwear.

It is also desirable for this footwear storage rack to comprise various modular, interchangeable components, so that a user can mix and match, or change the theme of the rack at will, thus adding further interest which acts as further inducement for the user to make good use of the rack for organized footwear storage.

### SUMMARY OF THE INVENTION

Disclosed herein is a themed footwear storage rack apparatus and related method, comprising: a base; a substantially vertically-oriented central support post attached to and maintained in said vertical orientation by said base; at least one tier of footwear support rods, each said footwear support rod comprising an attachment end thereof at which said support rod is attached to said central support post, and a distal end thereof; each said footwear support rod in each said tier connected at said attachment end thereof to said central support post, at: substantially the same vertical height, within four inches, as all other footwear support rods within said tier; a horizontal plane disposition angle theta which is substantially equal, within ten degrees, between each adjacent pair of support rods within said tier; and a vertical disposition angle phi of between 45 and 85 degrees from upward parallel alignment with said central support post; and a shoe rack theme embodied in a visual appearance of said central support post, well as on other components thereof.

### BRIEF DESCRIPTION OF THE DRAWINGS

The features of the invention believed to be novel are set forth in the appended claims. The invention, however, together with further objects and advantages thereof, may best be understood by reference to the following description taken in conjunction with the accompanying drawing(s) summarized below.

FIG. 1 illustrates a perspective view of one preferred embodiment of the invention, in which the shoe rack theme is that of baseball.

FIG. 2 illustrates a top-down cross section view of FIG. 1 along the view 2-2.

FIG. 3 illustrates a side cross-sectional view of FIG. 2 along the view 3-3.

FIG. 4 illustrates a method of using the embodiment illustrated in FIG. 1 for hanging footwear.

FIG. 5 illustrates the embodiment of FIG. 1, with modular (interchangeable) components.

### DETAILED DESCRIPTION

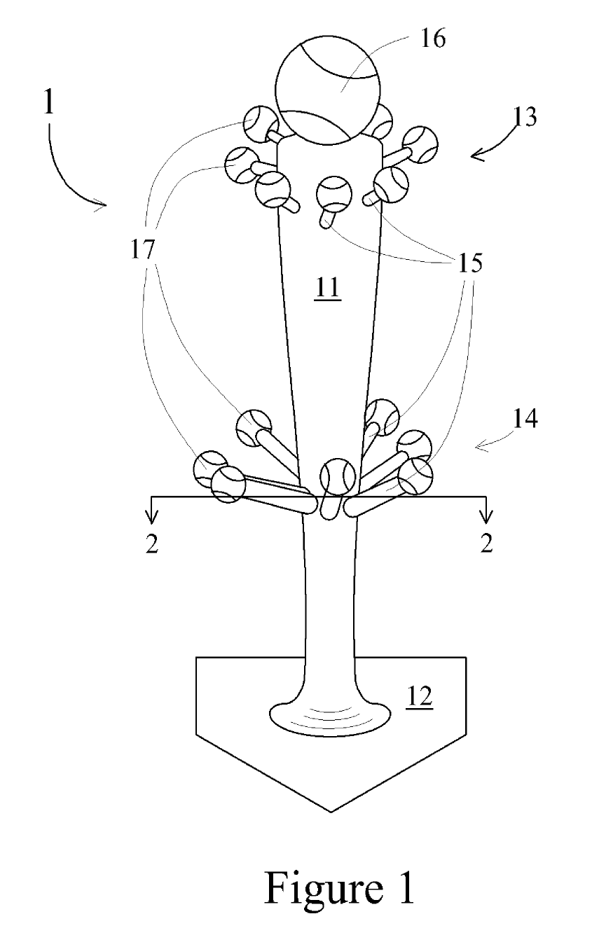

FIG. 1 is a perspective view of one preferred embodiment of the themed footwear storage rack apparatus invention 1, in which the shoe rack theme is that of “baseball,” which theme is used for illustrative example, not limitation.

Illustrated in FIG. 1 is a substantially vertically-oriented central support post 11 attached to and maintained in a vertical orientation by a base 12 thereof. In accordance with the illustrative “baseball” theme, central support post 11 comprises a “baseball bat” appearance while base 12 comprises a′home plate' appearance, both embodying this illustrative “baseball” theme. Attached to central support post 11 are two tiers 13 and 14 of footwear support rods 15. While two tiers are illustrated here, this is illustrative not limiting. In general, the themed footwear storage rack comprises at least one tier, but may have two, three, four, five, six, or even more tiers, dependent only on space considerations. Within a given tier, each footwear support rod 15 is connected at an attachment end thereof to the central support post 11 at substantially the same vertical height as all other footwear support rods in the same tier, is illustrated. As illustrated in photographs filed with applicant's provisional application U.S. 61/252,409 incorporated by reference, there may be a slight variation of perhaps one or two or three, and at most four inches in height among the connections of the footwear support rods 15 to the central support post 11, within any given tier. However, in relation to the overall height of the central support post 11, and as between one tier and the next, the attachments within a tier are regarded to be at “substantially” the same height so long as they are so-attached within about 4 inches of one another.

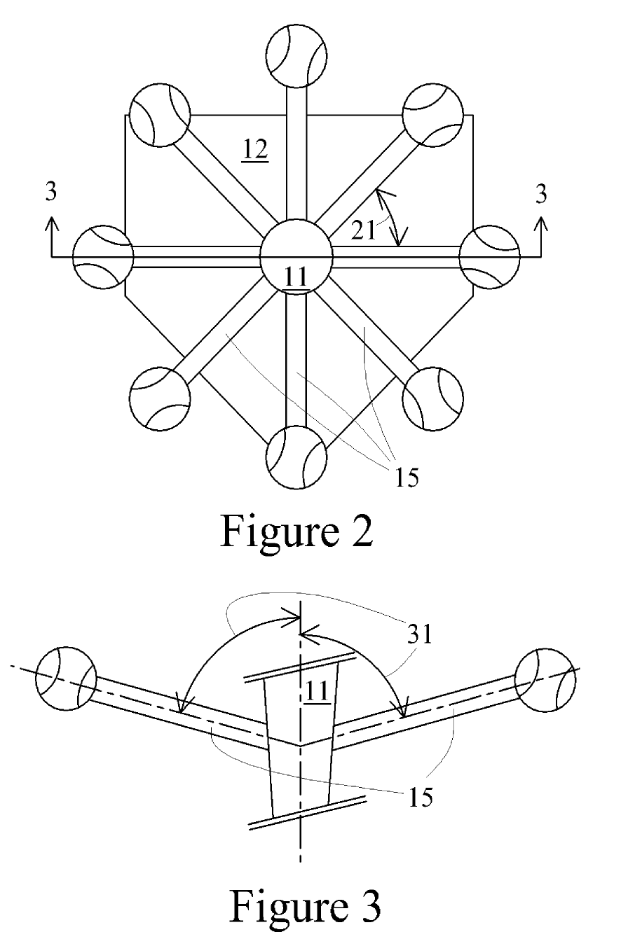

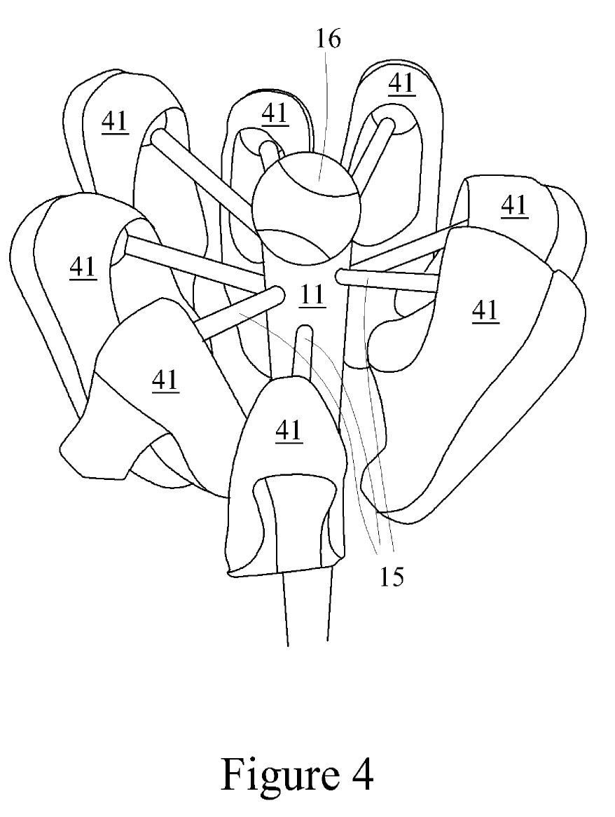

As illustrated in FIG. 2 which shows a top-down cross section view of FIG. 1 along the view 2-2, within the horizontal plane there is a horizontal plane disposition angle theta 21 which is substantially equal as between each adjacent pair of support rods 15 in a given tier, within 5 and at most 10 degrees. As further illustrated by FIG. 3 which shows a side cross-sectional view of FIG. 2 along the view 3-3, there is also a vertical disposition angle phi 31 for a given support rod 15, preferably, of approximately 75 degrees from upward parallel alignment with the central support post 11. While illustrated at 75 degrees, this vertical disposition angle phi 31 can be from as small as 45, 50, 55, 60 65 or 70 degrees, and as large as 80 or 85 degrees. Further, the angle of connection for any given support rod 15 can be varied within these ranges just enumerated, that is, it is not required that each connection of a support rod 15 to central support post 11 within a single tier or among different tiers have the same angle phi 31 as all the other connections to the support rod, but can be varied among different support rods 15 to be between 45 and 85 degrees as enumerated above. This range of angles is optimal for hanging shoes in a functionally efficient and compact manner.

As also illustrated most clearly in FIGS. 2 and 4, within each tier, there are preferably eight support rods 15. This places an approximate 45 degree angle (within 5 and at most 10 degrees as noted above) between each adjacent pair of support rods 15 in a given tier, and is an optimal configuration for compactly storing footwear. Notwithstanding the illustrations of FIGS. 2 and 4, it is envisioned within the scope of this disclosure and its associated claims that there may be as few as three and as many as twelve support rods 15 within any given tier (i.e., 3, 4, 5, 6, 7, 8, 9, 10, 11 or 12 support rods 15 per tier), and that the number of support rods 15 need not necessarily be the same from one tier to the next.

As noted above, the (baseball) theme of the shoe rack is embodied in the visual appearance of the base 12 (home plate) and the central support post 11 (baseball bat). In addition, the theme is also embodied in the visual appearance of a central support post attachment 16 (a baseball is illustrated for example, not limitation) atop the central support post. Further, the theme is embodied in the visual appearance distal end figurines 17 attached to at least some, and preferably all, of the distal ends of the footwear support rods 15. As used here, the “distal” end of any given support rods 15 is defined relative to its attachment to the central support post 11. As illustrated in FIG. 1, for example not limitation, the distal end figurines 17 comprise baseballs, in accord with the illustrative “baseball” theme.

The method of using this themed footwear storage rack is very straightforward. As illustrated in FIG. 4, which shows the top tier 13 (see FIG. 1) of footwear support rods 15, one simply hangs a plurality of shoes 41 upon the distal ends 17 of the support rods 15, one shoe for each footwear support rod 15. Depending upon the shape, these distal ends 17 not only serve by their appearance to embody the overall theme of the footwear storage rack apparatus, but help to hold the shoes in place in their hanging position. The preferred vertical disposition angle phi 31, as stated earlier, is between 45 and 85 degrees, though preferably is approximately 75 degrees, as this provides to be an optimal orientation for the proper hanging of footwear.

As noted above, the theme used for illustration in FIGS. 1 through 4 is that of “baseball,” but this is for example, not limitation. If one uses various “sports” as a theme, one might, for example not limitation, choose baseball, football, basketball, golf, tennis, soccer (including World Cup), ice hockey, field hockey, volleyball, lacrosse, bowling, track & field, auto racing, horse racing, cycling, billiards/pool, rugby, cricket, fishing, and the Olympics, etc. For golf, one might choose a “golf club” or “green's flag” and associated pole for central support post 11, and perhaps a “putting green,” or a “tee-off area” for base 12, replete with green grass. In fact, one might recess a “cup” into a “green” base, and then have the bottom of a “green's flag” recessed into the cup, just as for a real green and flag and cup. The central support post attachment 16 may be a large golf ball, or the above-noted “green's flag” (perhaps for the 18^{th} hole), and the distal end figurines 17 of the footwear support rods 15 may also contain golf balls, or, perhaps club heads (various irons or woods), or perhaps green's flags numbered for various holes. For basketball, central support post 11 may be an upright support topped by a central support post attachment 16 which is a basket and backboard. The base 12 might be lined as a center court “jump ball” area, and the distal end figurines 17 of the footwear support rods 15 may contain basketballs. For football one might use “goal posts” as the central support post 11, so that there are actually two “side-by-side” racks, one representing each upright of the goal post. For hockey, as with other sports that utilize an elongated implement (such as a baseball bat or a golf club), it is natural that one would use a “hockey stick” for central support post 11, with “hockey pucks” used for the central support post attachment 16 and distal end figurines 17 of the footwear support rods 15. The base may embody a “center ice” faceoff area. An inverted tennis racquet might be the central support post 11 for a tennis theme, with the footwear support rods 15 attached along the “handle” of the racquet. For lacrosse this might be a lacrosse stick, etc. Similarly, it will be apparent to someone of ordinary skill how this line of thinking extends to other sports.

For a theme based on hunting, which is another culturally-popular activity, one might have a central support post 11 which is a rifle, and the distal end figurines 17 of the footwear support rods 15 may contain images of different animals, i.e. deer, rabbit, moose, etc. For a general sports theme, one can mix and match various components, combining baseballs, golf balls, footballs, basketballs, soccer balls, and implements of each sport, into a single themed footwear storage rack apparatus with a generalized sports theme. Or, for a single sport, the distal end figurines 17 might represent particular teams. For example, for a football theme, these figurines might be helmets reproducing the helmets of various, e.g., college or professional teams.

Switching from culturally-popular sports themes to other culturally-popular themes, one might be a beer connoisseur. In that event, each support rod 15 might be embellished by a different beer bottle image at its distal end 17, e.g., Bud, Michelob, Heineken, Coors, etc. Or, one might develop a culturally-popular theme for music, or movies, etc. Other possible culturally, economically or educationally-popular themes, for example not limitation, may include hobbies such as stamp or coin collecting (or any other type of collecting), (economic) trades or professions such as plumbing, carpentry, electrician, doctor, lawyer, etc., movie and/or book characters, military services, e.g., Army, Navy, Air Force, Marines and Coast Guard, etc., countries of the world, states of the United States, planets in the solar system, etc.

Because all of the foregoing themes are provided by way of example, not limitation, it should be apparent to someone of ordinary skill that a wide range of culturally, economically or educationally-popular themes can be employed in accordance with this invention, all within the scope of this disclosure and its associated claims. Thus, the recitation of particular themes above, and of particular examples of how those themes might be visually embodied in a given footwear storage rack, are not to be taken as limiting in any way, but as examples which will enable someone of ordinary skill to arrive at other themes which are similarly covered by this disclosure and its associated claims. In all cases, the invention as encompassed by the claims is not limited by particular theme examples.

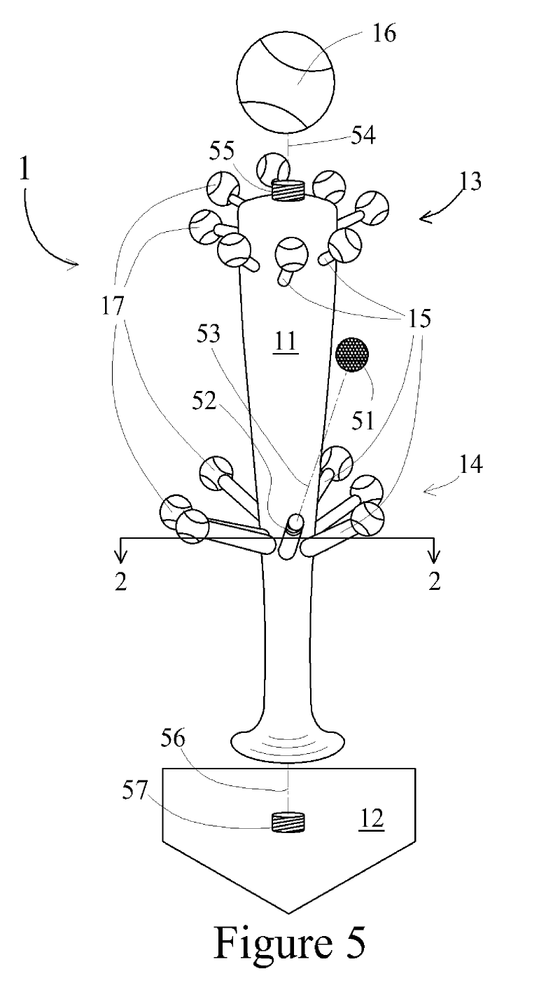

Finally, we turn to FIG. 5, which illustrates the embodiment of FIG. 1, with modular (interchangeable) components. For example, not limitation, this figure illustrates one of the distal ends figurines 17 comprising a removable figurine 51 which has the appearance of a golf ball, which is modularly attachable to and removable from the themed footwear storage rack apparatus 1. This ability to interchange modular components is achieved in this illustration by, for example not limitation, male distal end screw threads 52 which mate with the threads of a female receptacle (not shown) of the removable figurine 51, though it is understood that someone of ordinary skill can readily vary the way in which this interchangeability is achieved within the scope of this disclosure and its associated claims. Thus, figurine 51 is simply attached to or removed from the distal end screw threads 52 along mating line 53, by screwing and unscrewing. More generally, the distal end figurines 17 and said distal ends of the footwear support rods 15 are configured to attachably and detachably mate with one another, with the particular illustrated screw threading being but one example of how to achieve this.

Similarly in FIG. 5, central support post attachment 16 is also illustrated to be removable and attachable to central support post 11 along mating line 54 via, for example not limitation, post attachment screw threads 55, while central support post 11 is in turn also illustrated to be removable and attachable to base 12 along mating line 56 via, for example not limitation, base attachment screw threads 57. Again, the disclosure here, of mating systems comprising male and female screw threads, is but one non-limiting illustration of how this might be done within the scope of this disclosure and its associated claims. More generally, the base 12 and the central support post 11 may be configured to attachably and detachably mate with one another, and/or the central support post 11 and the central support post attachment 16 may be configured to attachably and detachably mate with one another.

The ability to interchange the modular components in this way, greatly improves the flexibility of themed footwear storage rack apparatus 1, resulting in a more desirable product. Thus, for example, if sold in an assembly kit which includes a variety of modular interchangeable components, for example not limitation, for baseball, football and basketball, one might assemble the baseball-themed components of this invention during early spring for use during the baseball season, disassemble and reassemble the invention with a football theme in the fall, and then, after the mid-winter Super Bowl as March Madness and the height of basketball season approaches, again disassemble and reassemble the invention with a basketball theme, using ornamentation perhaps further associated not only with the underlying sport, but also, with one's favorite teams. Thus, a product that is popular in New York because it features the Yankees and the Mets, would not be popular in Boston where fans will look for a Red Sox theme, etc. By using modular interchangeable components in this way for any or all of the components of this invention, the appeal to sports fans of all stripes is enhanced. One might even be able to later purchase, separately, new modular components after an initial purchase of this invention, enabling an never-ending variety or “collectable” themes and variations on a given theme. And, once again as noted earlier, the culturally, economically or educationally-popular themes discussed and illustrated here are for example only. These themes can be provided in any and all combinations with one another, and the enumeration of specific themes and combinations here, for purposes of illustration, do not limit the scope of applicant's claimed invention in any way.

The knowledge possessed by someone of ordinary skill in the art at the time of this disclosure is understood to be part and parcel of this disclosure and is implicitly incorporated by reference herein, even if in the interest of economy express statements about the specific knowledge understood to be possessed by someone of ordinary skill are omitted from this disclosure. While reference may be made in this disclosure to the invention comprising a combination of a plurality of elements, it is also understood that this invention is regarded to comprise combinations which omit or exclude one or more of such elements, even if this omission or exclusion of an element or elements is not expressly stated herein, unless it is expressly stated herein that an element is essential to applicant's combination and cannot be omitted. It is further understood that the related prior art may include elements from which this invention may be distinguished by negative claim limitations, even without any express statement of such negative limitations herein. It is to be understood, between the positive statements of applicant's invention expressly stated herein, and the prior art and knowledge of the prior art by those of ordinary skill which is incorporated herein even if not expressly reproduced here for reasons of economy, that any and all such negative claim limitations supported by the prior art are also considered to be within the scope of this disclosure and its associated claims, even absent any express statement herein about any particular negative claim limitations.

Finally, while only certain preferred features of the invention have been illustrated and described, many modifications, changes and substitutions will occur to those skilled in the art. It is, therefore, to be understood that the appended claims are intended to cover all such modifications and changes as fall within the true spirit of the invention.

I claim:

1. A themed footwear storage rack apparatus, comprising:
a base;
a substantially vertically-oriented central support post attached to and maintained in said vertical orientation by said base;
at least one tier of footwear support rods, each said footwear support rod comprising an attachment end thereof at which said support rod is attached to said central support post, and a distal end thereof;
each said footwear support rod in each said tier connected at said attachment end thereof to said central support post, at:
substantially the same vertical height, within four inches, as all other footwear support rods within said tier;
a horizontal plane disposition angle theta which is substantially equal, within ten degrees, between each adjacent pair of support rods within said tier; and
a vertical disposition angle phi of between 45 and 85 degrees from upward parallel alignment with said central support post; and
a shoe rack theme embodied in a visual appearance of distal end figurines attached to at least some of said distal ends of said footwear support rods.

2. The apparatus of claim 1, said shoe rack theme further embodied in a visual appearance of said central support post.

3. The apparatus of claim 1, said shoe rack theme further embodied in a visual appearance of said base.

4. The apparatus of claim 1, said shoe rack theme further embodied in a visual appearance of a central support post attachment atop said central support post.

5. The apparatus of claim 1, said shoe rack theme further embodied in a visual appearance of all of:
said central support post;
said base; and
a central support post attachment atop said central support post.

6. The apparatus of claim 1, wherein said vertical disposition angle is approximately 75 degrees.

7. The apparatus of claim 1, further comprising said distal end figurines and said distal ends of said footwear support rods configured to attachably and detachably mate with one another.

8. The apparatus of claim 3, further comprising said base and said central support post configured to attachably and detachably mate with one another.

9. The apparatus of claim 4, further comprising said central support post and said central support post attachment configured to attachably and detachably mate with one another.

10. The apparatus of claim 5, further comprising:
said distal end figurines and said distal ends of said footwear support rods configured to attachably and detachably mate with one another;
said base and said central support post configured to attachably and detachably mate with one another; and
said central support post and said central support post attachment configured to attachably and detachably mate with one another.

11. The apparatus of claim 1, said theme comprising at least one sport selected from the sport group consisting of: baseball, football, basketball, golf, tennis, soccer, ice hockey, field hockey, volleyball, lacrosse, bowling, track & field, auto racing, horse racing, cycling, billiards/pool, rugby, cricket, and the Olympics.

12. The apparatus of claim 5, said theme comprising at least one sport selected from the sport group consisting of: baseball, football, basketball, golf, tennis, soccer, ice hockey, field hockey, volleyball, lacrosse, bowling, track & field, auto racing, horse racing, cycling, billiards/pool, rugby, cricket, and the Olympics.

13. The apparatus of claim 10, said theme comprising at least one sport selected from the sport group consisting of: baseball, football, basketball, golf, tennis, soccer, ice hockey, field hockey, volleyball, lacrosse, bowling, track & field, auto racing, horse racing, cycling, billiards/pool, rugby, cricket, and the Olympics.

14. A method for assembling a themed footwear storage rack apparatus, comprising:
providing a base of said apparatus;
attaching a central support post to said base, and maintaining said central support post in a substantially vertical orientation by the attachment to said base;
attaching at least one tier of footwear support rods at an attachment end thereof, to said central support post, each said footwear support rod further comprising a distal end thereof;
connecting each said footwear support rod in each said tier at said attachment end thereof to said central support post, at:
substantially the same vertical height, within four inches, as all other footwear support rods within said tier;
a horizontal plane disposition angle theta which is substantially equal, within ten degrees, between each adjacent pair of support rods within said tier; and
a vertical disposition angle phi of between 45 and 85 degrees from upward parallel alignment with said central support post; and
embodying said shoe rack theme in a visual appearance of distal end figurines attached to at least some of said distal ends of said footwear support rods.

15. The method of claim 14, further comprising embodying a shoe rack theme in a visual appearance of said central support post.

16. The method of claim 14, further comprising embodying said shoe rack theme in a visual appearance of said base.

17. The method of claim 14, further comprising embodying said shoe rack theme in a visual appearance of a central support post attachment atop said central support post.

18. The method of claim 14, further comprising embodying said shoe rack theme in a visual appearance of all of:
said central support post;
said base;
a central support post attachment atop said central support post.

19. The method of claim 14, wherein said vertical disposition angle is approximately 75 degrees.

20. The method of claim 14, said distal end figurines and said distal ends of said footwear support rods configured to attachably and detachably mate with one another, further comprising:
interchangeably attaching said distal end figurines and said distal ends of said footwear support rods to one another.

21. The method of claim 16, said base and said central support post configured to attachably and detachably mate with one another, further comprising:
interchangeably attaching said base and said central support post to one another.

22. The method of claim 17, said central support post and said central support post attachment configured to attachably and detachably mate with one another, further comprising:
interchangeably attaching said central support post and said central support post attachment to one another.

23. The method of claim 18:
said distal end figurines and said distal ends of said footwear support rods configured to attachably and detachably mate with one another;
said base and said central support post configured to attachably and detachably mate with one another; and
said central support post and said central support post attachment configured to attachably and detachably mate with one another, further comprising:
interchangeably attaching said distal end figurines and said distal ends of said footwear support rods to one another;
interchangeably attaching said base and said central support post to one another; and
interchangeably attaching said central support post and said central support post attachment to one another.

24. The method of claim 14, said theme comprising at least one sport selected from the sport group consisting of: baseball, football, basketball, golf, tennis, soccer, ice hockey, field hockey, volleyball, lacrosse, bowling, track & field, auto racing, horse racing, cycling, billiards/pool, rugby, cricket, and the Olympics.

25. The method of claim 18, said theme comprising at least one sport selected from the sport group consisting of: baseball, football, basketball, golf, tennis, soccer, ice hockey, field hockey, volleyball, lacrosse, bowling, track & field, auto racing, horse racing, cycling, billiards/pool, rugby, cricket, and the Olympics.

26. The method of claim 23, said theme comprising at least one sport selected from the sport group consisting of: baseball, football, basketball, golf, tennis, soccer, ice hockey, field hockey, volleyball, lacrosse, bowling, track & field, auto racing, horse racing, cycling, billiards/pool, rugby, cricket, and the Olympics.

27. The method of claim 14, further comprising a method for storing footwear using said themed footwear storage rack apparatus, said method for storing footwear comprising:
hanging a footwear item on the distal end of one of said footwear support rods.

28. The method of claim 27, further comprising hanging a plurality of footwear items on the distal ends of said footwear support rods.
